(19) United States
(12) Patent Application Publication
(10) Pub. No.: US 2012/0013694 A1
(43) Pub. Date: Jan. 19, 2012

(54) TRANSFER INK JET RECORDING APPARATUS

(75) Inventor: Tsuyoshi Kanke, Yokohama-shi (JP)

(73) Assignee: CANON KABUSHIKI KAISHA, Tokyo (JP)

(21) Appl. No.: 13/164,470

(22) Filed: Jun. 20, 2011

(30) Foreign Application Priority Data
Jul. 13, 2010 (JP) 2010-158795

(51) Int. Cl. B41J 2/01

(52) U.S. Cl. 347/103

(57) ABSTRACT

Disclosed herein is a transfer ink jet recording apparatus equipped with a substrate; an intermediate transfer member that is arranged on the substrate and has a surface containing at least one material of fluorine-containing rubber and silicone rubber, said surface being subjected to a modification treatment by a plasma treatment and an application treatment with a compound represented by the general formula (1) defined in the specification; an application unit for applying a component that causes ink viscosity increase to the modification-treatment-subjected surface of the intermediate transfer member; an ink jet recording unit for ejecting an ink on the intermediate transfer member to which the component has been applied to form an intermediate image; and a transfer unit for transferring the intermediate image formed on the intermediate transfer member to a recording medium.

### BACKGROUND OF THE INVENTION

1. Field of the Invention

The present invention relates to a transfer ink jet recording apparatus.

2. Description of the Related Art

In general, a transfer ink jet recording method has the following steps: an intermediate image forming step of applying an ink containing a coloring material component to an intermediate transfer member to which a reaction liquid for forming a viscosity increased ink image (intermediate image) by coming into contact with the coloring material in the ink has been applied, by means of an ink jet device to form an intermediate image; and a transfer step of bringing the intermediate transfer member, on which the intermediate image has been formed, into contact under pressure with a recording medium to transfer the intermediate image to the recording medium. A transfer ink jet recording apparatus equipped with the intermediate transfer member used in this transfer ink jet recording method is required to show high ability to hold the intermediate image on the intermediate transfer member for obtaining a high-quality recorded image.

Japanese Patent Application Laid-Open No. 2005-014255 discloses an intermediate transfer member capable of showing high ability to hold the intermediate image. This intermediate transfer member has a surface formed of at least one material of a fluorine compound and a silicone compound, which are excellent in releasability, and is subjected to a surface modification treatment by a plasma treatment and a surfactant application treatment. The surface formed of at least one of the fluorine compound and the silicone compound is thereby hydrophilizated while retaining excellent releasability, whereby an image can be formed on the intermediate transfer member without repelling an ink thereon to develop the high ability to hold the intermediate image.

In the intermediate transfer member disclosed in Japanese Patent Application Laid-Open No. 2005-014255, the hydrophilic surface is stably formed by the plasma treatment and the surfactant application treatment. However, the hydrophilicity of the surface may have been gradually changed in some cases when the intermediate transfer member is left to stand for a longer period of time than that conventionally assumed. In this case, it has been confirmed that when the contact angle of water against the intermediate transfer member is measured, the value thereof gradually increases. From this, the hydrophilicity of the surface of the intermediate transfer member may have been gradually lowered by leaving the intermediate transfer member to stand for a long period of time in some cases to finally repel the ink thereon, resulting in a failure to form an intermediate image on the intermediate transfer member.

### SUMMARY OF THE INVENTION

The present invention has been made in view of the problem described above. It is an object of the present invention to solve the problem by improving the prior art techniques. More specifically, the object of the present invention is as follows. In short, the object is to provide a transfer ink jet recording apparatus equipped with an intermediate transfer member capable of stably retaining the hydrophilicity of the surface thereof without gradually changing it even when left to stand for a long period of time and forming a good image owing to its high ability to hold an intermediate image.

The transfer ink jet recording apparatus according to the present invention, which solves the above problem, comprises a substrate; an intermediate transfer member that is arranged on the substrate and has a surface containing at least one material of a fluorine-containing rubber and a silicone rubber, said surface being subjected to a modification treatment by a plasma treatment and an application treatment with a compound represented by the following general formula (1):

HO-(AO)ₙ—H General formula (1)

wherein A is an ethylene or propylene group, and n is an integer of 3 to 50; an application unit for applying a component that causes ink viscosity increase to the modification-treatment-subjected surface of the intermediate transfer member; an ink jet recording unit for ejecting an ink on the intermediate transfer member to which the component has been applied to form an intermediate image; and a transfer unit for transferring the intermediate image formed on the intermediate transfer member to a recording medium.

According to the present invention, there can be provided a transfer ink jet recording apparatus equipped with an intermediate transfer member capable of stably retaining the hydrophilicity of the surface thereof without gradually changing it even when left to stand for a long period of time and forming a good image owing to its high ability to hold an intermediate image.

Further features of the present invention will become apparent from the following description of exemplary embodiments with reference to the attached drawings.

### BRIEF DESCRIPTION OF THE DRAWINGS

FIG. 1 illustrates the construction of a principle part of a transfer ink jet recording apparatus according to a first embodiment.

FIG. 2 illustrates the construction of a principle part of a transfer ink jet recording apparatus according to a second embodiment.

### DESCRIPTION OF THE EMBODIMENTS

Preferred embodiments of the present invention will now be described in detail in accordance with the accompanying drawings. However, constituent elements described in the embodiments are examples, and the scope of the present invention is not limited only thereto. The embodiments will hereinafter be described as examples of the transfer ink jet recording apparatus. Incidentally, when the transfer ink jet recording apparatus according to the present invention is used, the hydrophilicity of the intermediate transfer member can be stably retained, and moreover both high ability to hold an intermediate image on the intermediate transfer member and high ability to transfer the intermediate image from the intermediate transfer member can be achieved.

Transfer Ink Jet Recording Apparatus:

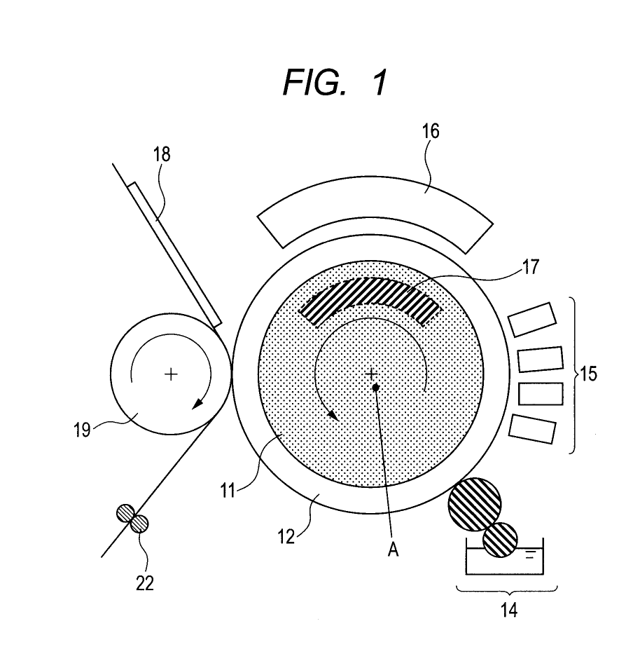

FIG. 1 illustrates the construction of a principle part of a transfer ink jet recording apparatus according to a first embodiment. The transfer ink jet recording apparatus is equipped with an intermediate transfer member 12 that is driven to rotate counter-clockwise about a shaft A of a substrate 11, wherein the intermediate transfer member 12 is arranged on the substrate 11. The surface of this intermediate transfer member 12 contains at least one material of a fluorine-containing rubber and a silicone rubber. In addition, this surface has been previously subjected to a hydrophilicity-imparting treatment by performing a surface modification by a plasma treatment and an application treatment with a compound represented by the following general formula (1):

HO-(AO)ₙ—H General formula (1)

In the general formula (1), A is an ethylene or propylene group. The propylene group may be either linear or branched. A is favorably an ethylene group. n is an integer of 3 to 50. n is favorably an integer of 20 or less, more favorably an integer of 15 or less. Incidentally, even when a compound with 2 or less of the alkyleneoxy chains is used in place of the compound represented by the general formula (1), the surface of the intermediate transfer member may be temporally improved to be a hydrophilic surface by applying the compound to the surface of the intermediate transfer member after the plasma treatment. However, this compound is liable to be volatilized out of the surface of the intermediate transfer member, so that a sufficient effect cannot be achieved compared with the compound of the general formula (1) from the viewpoint of retaining the hydrophilicity. Further, when another compound having 3 or more alkyleneoxy chains in its molecular structure is applied to the surface of the intermediate transfer member in place of the compound represented by the general formula (1), the effect to retain the hydrophilicity cannot be sufficiently achieved compared with the compound of the general formula (1) according to the present invention. A component that causes ink viscosity increase (ink viscosity increasing component) is applied to the surface of the intermediate transfer member on which the modification treatment has been made by a coating device 14 arranged being in contact with the intermediate transfer member 12. In addition, an ink is ejected from an ink jet recording part 15 after these components have been applied to form an intermediate image (mirror image) on the surface of the intermediate transfer member 12. Incidentally, the transfer ink jet recording apparatus may be equipped with a blower 16 and a heater 17 for the purpose of evaporating water and solvent components in the ink making up the intermediate image formed on the surface of the intermediate transfer member as illustrated in FIG. 1. A recording surface of a recording medium 18 is brought into contact with the image formed on the surface of the intermediate transfer member and pressed from a back side of the recording medium by a pressure roller 19, thereby transferring the image to the recording medium 18. The intermediate transfer member 12 gets ready for the next image forming process after this series of the recording steps.

The ink jet recording apparatus according to the first embodiment as illustrated in FIG. 1 is equipped with the following units: the intermediate transfer member 12 arranged on the substrate 11; the coating device 14 that is an application unit for applying the component that causes ink viscosity increase to the surface of the intermediate transfer member; the ink jet recording part 15 that is an ink jet recording unit for ejecting an ink on the intermediate transfer member to which the ink viscosity increasing component has been applied to form an image; and the pressure roller 19 that is a transfer unit for transferring the image to the recording medium 18.

In addition, as needed, the transfer ink jet recording apparatus may also be equipped with the blower 16 and the heater 17 that are water-and-solvent-removing units for accelerating the removal of water and solvent components in the ink. Fixing rollers 22 may also be installed.

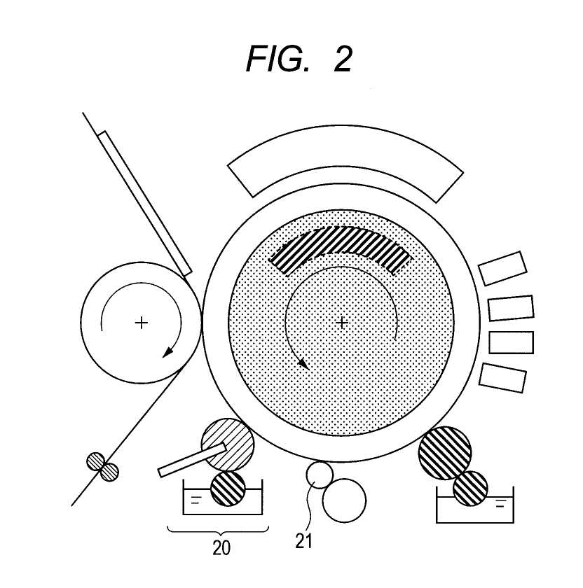

FIG. 2 illustrates the construction of a principle part of a transfer ink jet recording apparatus according to a second embodiment. Like the ink jet recording apparatus according to the first embodiment as illustrated in FIG. 1, the ink jet recording apparatus according to the second embodiment is equipped with the following units: an intermediate transfer member arranged on a substrate; an application unit for applying a component that causes ink viscosity increase to the surface of the intermediate transfer member; an ink jet recording unit; and a transfer unit for transferring an image to a recording medium. In addition, as needed, water-and-solvent-removing units for accelerating the removal of water and solvent components in the ink may also be installed. Further, the ink jet recording apparatus according to the second embodiment is equipped with an application unit 20 that is a unit for applying the compound represented by the general formula (1) to the surface of the intermediate transfer member. According to this transfer ink jet recording apparatus, the compound represented by the general formula (1) is additionally applied to the modification-treatment-subjected surface of the intermediate transfer member by means of the application unit 20 during operation to conduct an additional surface modification treatment, whereby the effect to retain the hydrophilicity of the intermediate transfer member can be further enhanced. Incidentally, the compound represented by the general formula (1) is applied as a water-soluble organic solvent to the surface of the intermediate transfer member, whereby the effect to retain the hydrophilicity of the intermediate transfer member can be enhanced.

The transfer ink jet recording apparatus may also be equipped with a removal unit 21 for removing the excess portion of the compound represented by the general formula (1) supplied by the application unit 20 for applying the compound represented by the general formula (1).

In the ink jet recording apparatus according to the second embodiment, the compound represented by the general formula (1) is applied to the intermediate transfer member 12 according to necessary timing by the application unit 20. The intermediate transfer member 12 gets ready for the next image forming process after this series of the recording steps.

In short, an image can be formed on a recording medium by means of the recording apparatus according to the present invention by a transfer ink jet recording method including the following steps:

Step (1): providing an intermediate transfer member arranged on a substrate and having a surface containing at least one material of a fluorine-containing rubber and a silicone rubber, said surface being subjected to a modification treatment by a plasma treatment and an application treatment with the compound represented by the general formula (1);
Step (2): applying a component that causes ink viscosity increase to the modification-treatment-subjected surface of the intermediate transfer member;
Step (3): ejecting an ink on the intermediate transfer member to which the component has been applied by means of an ink jet recording unit to form an intermediate image; and
Step (4): transferring the intermediate image formed on the intermediate transfer member to a recording medium.

In addition, a step of accelerating the removal of water and solvent components in the ink making up the intermediate image may also be included between Step (3) and Step (4). Further, the following step may also be included. A step of applying the compound represented by the general formula (1) to the surface of the intermediate transfer member. This step may be conducted after Step (4) and before the next recording is started (before Step (2)).

The ink jet recording apparatus according to the present invention will hereinafter be described in detail with reference to specific examples.

Substrate:

As the substrate 11, that publicly known as a substrate for the intermediate transfer member may be chosen for use as needed. However, a drum made of a light metal such as an aluminum alloy is favorably used as the substrate from the viewpoints of stiffness withstanding a pressure upon transfer, dimensional accuracy and properties required to relieve rotational inertia to improve responsiveness to control. In the embodiments illustrated in FIGS. 1 and 2, the drum-shaped substrate 11 is illustrated, and the intermediate transfer member 12 is provided on the peripheral surface of the drum. As the shape of the substrate 11, any shape may be used so far as the surface of the intermediate transfer member 12 comes into at least linear contact with the recording medium 18. Specifically, a sheet-shaped, roller-shaped, belt-shaped or endless-web-shaped substrate may be used according to the mode of an image forming apparatus to be applied and a manner to transfer the intermediate image to the recording medium 18.

Intermediate Transfer Member:

The intermediate transfer member 12 used in the present invention is provided on the substrate 11, whereby the whole shape may be in the form of a sheet, roller, belt or endless web. This shape may be suitably selected according to the mode of the image forming apparatus to be applied and the manner to transfer the intermediate image to the recording medium 18. A material with large elastic deformation, such as a pad used in, for example, pad printing, may be used in the intermediate transfer member so far as the material satisfies the conditions for the intermediate transfer member used in the present invention.

The intermediate transfer member used in the present invention contains at least one of a fluorine-containing rubber and a silicone rubber in its surface. The intermediate transfer member may also be formed of one layer or 2 or more layers. In other words, that obtained by forming a layer (rubber layer) containing at least one of a fluorine-containing rubber and a silicone rubber on the surface of a material publicly known as an intermediate transfer member used in the transfer ink jet recording method may be used as the intermediate transfer member. In addition, that formed by using a material containing either one of a fluorine-containing rubber and a silicone rubber may be used as the intermediate transfer member. The thickness of the rubber layer of the intermediate transfer member is preferably controlled to 0.05 mm or more from the viewpoint of strength. However, the thickness of the rubber layer is favorably controlled to 5 mm or less from the viewpoint of easy prevention of image disturbance due to rubbery deformation upon its contact under pressure for transfer, which is caused by the large thickness of the rubber layer. The total thickness of the intermediate transfer member having the rubber layer on its surface is favorably controlled to 10 mm or less for the same reason. The total content of these rubbers in the surface of the intermediate transfer member before subjected to the application treatment with the compound of the general formula (1) is favorably controlled to 25% by mass or more and 100% by mass or less based on the total mass of the intermediate transfer member. The surface of the intermediate transfer member may contain, in addition to these rubbers, other rubbers such as chloroprene rubber, nitrile rubber, ethylene propylene rubber, natural rubber, styrene rubber, isoprene rubber, butadiene rubber, ethylene/propylene/butadiene terpolymers and nitrile butadiene rubber, and various fillers. Incidentally, whether the surface of the intermediate transfer member contains at least one material of a fluorine-containing rubber and a silicone rubber or not can be identified by elementary analysis.

The intermediate transfer member having these rubbers in its surface has excellent releasability to inks and is thus excellent in transfer rate upon transfer of the intermediate image. The fluorine-containing rubber and silicone rubber described herein are intended to include oils thereof, and a material containing these oils is an important material capable of increasing the transfer rate in particular. Incidentally, the releasability means a nature capable of being released without sticking, and the feature that the intermediate transfer member has releasability to inks means such a condition that the intermediate image is capable of being removed without sticking to the surface of the intermediate transfer member. Higher releasability is advantageous from the viewpoints of burden upon cleaning and the transfer rate of the ink. On the other hand, the critical surface tension of a material generally becomes lower as the releasability is higher, and so such a material easily repel a liquid such as an ink when the liquid is applied thereto, resulting in difficulty to hold an image.

The surface of the intermediate transfer member, which contains at least one of a fluorine-containing rubber and a silicone rubber that are releasable materials favorably used, favorably satisfies the following physical properties prior to a surface modification treatment (plasma treatment and application treatment with the compound represented by the general formula (1)), which will be described subsequently. More specifically, it is favorable that the critical surface tension of the surface is 30 mN/m or less, or the contact angle against pure water is 70° or more and thus the surface exhibits water repellency. In short, the surface is favorably formed of such a material that when an ink is applied to the intermediate transfer member simply by an ordinary method, the ink is repelled not to form an image (i.e., a material low in the ability to hold the intermediate image). More specifically, the intermediate transfer member prior to the surface modification treatment can also be formed by subjecting the surface of a material publicly known as the intermediate transfer member to a surface treatment, for example, fluorine processing or coating with silicone oil. However, the intermediate transfer member is more favorably formed by using an elastomeric material having releasability in that a higher transfer efficiency can be achieved. As the elastomeric material having releasability, a fluorine-containing rubber or silicone rubber containing an oil component may be specifically used. Incidentally, the critical surface tension of the surface of the intermediate transfer member can be determined by the Zisman plot method. According to the Zisman plot method, various solutions different in surface tension from one another are first used to measure their contact angles against a solid surface. The surface tensions are then plotted on an axis of abscissa, and the cosine (cos) of the contact angles of the respective droplets are plotted on an axis of ordinate, thereby obtaining a linear relationship. The resultant straight line is extrapolated, and an axis of abscissa (surface tension value) at which cos θ=1 (intersection) is given is regarded as a critical surface tension of the solid. This method is widely used when whether the solid surface is easy to be wetted with a liquid or not (wettability) is quantified. The contact angle against pure water can be measured according to the method described in JIS R 3257, “6. Static method”.

Silicone rubber includes various types such as vulcanizing type, one-component curing type and two-component curing type, and any type may be suitably used. The rubber hardness of the elastomeric material forming the intermediate transfer member (rubber layer) is desirably optimized according to the thickness and hardness of the recording medium 18 brought into contact therewith because the intermediate transfer member is affected thereby. However, an elastomeric material having a rubber hardness of 10° or more and 100° or less as measured by Durometer Type A (according to JIS K 6253) is favorably used because the effect of the present invention is easily achieved, and that having a rubber hardness of 20° or more and 60° or less is more favorable.

Surface modification treatment of intermediate transfer member:

The surface of the intermediate transfer member containing at least one of a fluorine-containing rubber and a silicone rubber is subjected to a modification treatment by a plasma treatment and an application treatment with the compound represented by the general formula (1). Incidentally, the application treatment with the compound of the general formula (1) is favorably conducted after the plasma treatment.

In the step of subjecting the surface of the intermediate transfer member to the modification treatment, the surface modification is conducted by applying the plasma treatment and the application treatment with the compound represented by the general formula (1) to the surface of the intermediate transfer member 12. Materials excellent in releasability, such as a fluorine-containing rubber and a silicone rubber, generally exhibit such a property that their critical surface tensions are low and tend to repel a liquid such as an ink or an ink viscosity increasing component, which will be described subsequently. Thus, it is difficult to form an intermediate image on the intermediate transfer member as they are. Accordingly, the surface modification is conducted by the above-described treatments, thereby inhibiting the repelling of the ink.

As a plasma treatment unit, such a type that the treatment is conducted under an atmosphere of atmospheric or reduced pressure is general, and either type may be favorably used. Here, the plasma treatment includes a corona discharge treatment by which oxygen in the air can be activated to create a hydroxyl group on the surface. Incidentally, as the plasma treatment unit, may be used, for example, an atmospheric plasma treatment apparatus (manufactured by KEYENCE CORPORATION, trade name: ST-7000). After the surface of the intermediate transfer member is subjected to the plasma treatment, the compound represented by the general formula (1) is applied thereto to complete the surface modification. By this surface modification, the effect by the surface modification can be sustained over a long period of time. As a unit for applying the compound of the general formula (1), one with which the application is conducted by roll coating, doctor coating or spray coating is favorable. However, one with which the application is conducted by dip coating, which is a batch treatment, may achieve the same effect according to the mode of an image forming apparatus to be applied. This surface modification unit has not only a hydrophilizating effect but also an effect not to lower or to improve an ink transfer rate upon transferring of an image formed on the intermediate transfer member to a recording medium, which is a subsequent step.

The mechanism by which the favorable effect is achieved by such selected materials and selected surface modification units is not yet completely elucidated. However, when at least one of a fluorine component and a silicone oil component is present, it is apparent that both hydrophilization of the surface and retention or improvement of the transfer rate are markedly achieved, and these effects tend to be lastingly achieved when the surface modification treatment is conducted once. From these facts, it is inferred that at least a part of the rubber component, filler component and oil component contained in the fluorine-containing rubber and silicone rubber on the surface of the intermediate transfer member is hydrophilizated by a chemical action that is an effect by the plasma treatment (introduction of a hydrophilic group into the surface), which is generally told. In addition, it is inferred that a part of the rubber structure is broken down by a physical action (surface roughening) to accelerate the surface migration of the oil component. Further, it is inferred that when the compound of the general formula (1) is applied, this compound is adsorbed on the surface which has been in a high energy state by the plasma treatment to introduce a hydrophilic group into the surface, whereby the surface becomes a more stable hydrophilic surface to sustain the hydrophilicity of the surface for an extremely long period of time. In fact, the effect becomes higher as the time interval between the plasma treatment and the application of this compound is shorter, and there is a tendency for the correlation with the deactivation time of plasma to be high. Incidentally, the intermediate transfer member subjected to the surface modification may be subjected to a treatment in the next step after the excess portion of the compound is removed generally by a water washing unit.

In the present invention, the compound represented by the general formula (1) is applied to the surface of the intermediate transfer member. Incidentally, this compound may be applied to the surface of the intermediate transfer member singly or as a mixed liquid with, for example, water. The compound represented by the general formula (1) is excellent in the effect to retain the hydrophilicity of the surface of the intermediate transfer member. Specific examples of the compound represented by the general formula (1) include triethylene glycol, tetraethylene glycol, polyethylene glycol, tripropylene glycol and polypropylene glycol. Among these, compounds in which A (alkylene group) in the general formula (1) is an ethylene group and n is an integer of 3 Or more are particularly favorable. Specifically, triethylene glycol, tetraethylene glycol and polyethylene glycol are particularly favorable among the polyalkylene glycols. The weight-average molecular weight of polyethylene glycol is favorably 200 or more and 800 or less, more favorably 400 or more and 800 or less. Incidentally, the following compound may also be applied together with the compound of the general formula (1) to the surface of the intermediate transfer member, and the mixed liquid of the compound of the general formula (1) and water may further contain the following compound. In other words, the mixed liquid may contain a compound having 2 or less alkyleneoxy chains, such as ethylene glycol or diethylene glycol, i.e. such a polyhydric alcohol that n in the general formula (1) is an integer of 2 or less, such as glycol or glycerol, in addition to the compound represented by the general formula (1).

When the compound represented by the general formula (1) is applied as a mixed liquid with water or with another compound such as ethylene glycol, or with water and another compound, the content of the compound represented by the general formula (1) in this mixed liquid is favorably 30% by mass or more and 100% by mass or less from the viewpoint of retention of the hydrophilicity of the surface of the intermediate transfer member.

Application unit for applying ink viscosity increasing component:

When an intermediate image is formed on the intermediate transfer member by means of an ink jet recording unit, beading or bleeding occurs when next ink droplets come into contact with ink droplets previously applied before the ink droplets are sufficiently dried, thereby disturbing an image to be formed. In order to prevent these phenomena, it is practically effective to apply a component that causes ink viscosity increase to the intermediate transfer member. Hereinafter, a solution containing the ink viscosity increasing component may also be referred to as a reaction liquid. When the transfer ink jet recording apparatus illustrated in FIG. 1 or 2 is used, a coating device 14 is used as an application unit to apply the ink viscosity increasing component to the surface of the intermediate transfer member on which the modification treatment has been made. Here, the ink viscosity increasing component is a component that comes into contact with a coloring material and/or a resin, which is a part of an ink, thereby causing these coloring material and resin to be chemically reacted or physically adsorbed to increase the viscosity of the whole ink. The ink viscosity increasing component also includes, not limited thereto, a component locally causing viscosity increase by aggregating a part of the ink, such as the coloring material.

The ink viscosity increasing component is desirably suitably selected according to the kind of an ink used in the formation of an image. For example, at least one of a metal ion and a hydrogen ion is effectively used for a pigment ink in which fine particles are dispersed, and an aqueous solution containing them is favorably applied to the surface of the intermediate transfer member. A polymer coagulant is effectively used for a dye ink.

Specific examples of the metal ion usable as the ink viscosity increasing component include divalent metal ions such as Ca²⁺, Cu²⁺, Ni²⁺, Mg²⁺, Sr²⁺, Ba²⁺ and Zn²⁺, and trivalent metal ions such as Fe³⁺, Cr³⁺, Y³⁺ and Al³⁺. When a liquid containing such a metal ion is applied, an aqueous solution of a metal salt is desirably applied. Examples of an anion forming the metal salt include Cl⁻, NO₃⁻, CO₃²⁻, SO₄²⁻, I⁻, Br⁻, ClO₃⁻, HCOO⁻ and RCOO⁻ (R being an alkyl group).

The hydrogen ion specifically usable as the ink viscosity increasing component is favorably used as a solution containing the hydrogen ion, and an acidic solution having a pH less than 7 is favorably used. Examples thereof include inorganic acids such as hydrochloric acid, phosphoric acid, sulfuric acid, nitric acid and boric acid, and organic acids such as oxalic acid, polyacrylic acid, acetic acid, glycolic acid, malonic acid, malic acid, maleic acid, ascorbic acid, succinic acid, glutaric acid, fumaric acid, citric acid, tartaric acid, lactic acid, pyrrolidonecarboxylic acid, pyronecarboxylic acid, pyrrolecarboxylic acid, furancarboxylic acid, pyridinecarboxylic acid, coumalic acid, thiophenecarboxylic acid and nicotinic acid. Derivatives of these compounds and solutions of salts thereof may also be favorably used.

An acid buffer having pH buffering capacity is favorably used as the reaction liquid because its reactivity to an ink does not decline owing to little variation in pH even when the apparent concentration of the reaction liquid is lowered by the ink. In order to obtain the pH buffering capacity, it is favorable to contain a buffer in the reaction liquid. Specific examples of the buffer usable include acetates such as sodium acetate, potassium acetate and lithium acetate, hydrogenphosphates, hydrogencarbonates, and hydrogen salts of polyvalent carboxylic acids, such as sodium hydrogenphthalate and potassium hydrogenphthalate. Specific examples of the polyvalent carboxylic acids include malonic acid, maleic acid, succinic acid, fumaric acid, itaconic acid, isophthalic acid, terephthalic acid, adipic acid, sebacic acid, dimeric acid, pyromellitic acid and trimellitic acid in addition to phthalic acid. Besides these compounds, any of conventionally known compounds exhibiting a buffering action to the pH through its addition may be favorably used. The reaction liquid used in the present invention may contain a proper amount of water and/or an organic solvent.

Examples of the polymer flocculant used as the ink viscosity increasing component include cationic polymer flocculants, anionic polymer flocculants, nonionic polymer flocculants and amphoteric polymer flocculants.

The application amount of the ink viscosity increasing component is favorably smaller from the viewpoint of flow of the intermediate image and drying characteristics. However, the amount is desirable controlled in such a manner that the total number of electric charges of the metal ion or hydrogen ion is twice or more as much as the total number of electric charges of the reversed-polarity ion in a color ink from the viewpoint of reactivity. As the coating unit, the coating device 14 of the roll coater type is illustrated in FIGS. 1 and 2 as a favorable example. However, not limited thereto, for example, a spray coater may also be used. Further, a recording head which ejects a liquid of the ink viscosity increasing component by an ink jet system may also be used. It may be better in some cases to apply an ink after the ink viscosity increasing component is sufficiently dried by adding a drying step after the coating of the ink viscosity increasing component. In such a case, a drying unit may be added between the coating device 14 and the ink jet recording part 15.

In order to improve the fastness properties of an image finally formed, a water-soluble resin and a water-soluble crosslinking agent may also be added to the reaction liquid. Any material may be suitably used without limitation so far as it can coexist with the ink viscosity increasing component. As the water-soluble resin, may be favorably used an organic polymer such as polyvinyl alcohol or polyvinylpyrrolidone. As the water-soluble crosslinking agent, is favorably used oxazoline or carbodiimide which reacts with a carboxylic acid suitably used for dispersing the coloring material in the ink. Allysine is a material that can relatively achieve both ink viscosity increase and fastness properties of the image. These resins may be dissolved in a solvent of the reaction liquid, or may be added in an emulsion state or suspension state. In order to uniformly apply the ink viscosity increasing component, it is effective to add a surfactant into the reaction liquid.

Ink jet recording unit for forming intermediate image on intermediate transfer member:

As described above, the surface of the intermediate transfer member is sufficiently hydrophilizated by the surface modification of the intermediate transfer member, and the component that causes ink viscosity increase is applied thereto. Therefore, even when ink jet recording is conducted with an ink, in particular, an aqueous ink, an image can be formed without repelling the ink on the surface of the intermediate transfer member. With respect to the ink jet recording part used for the formation of the ink, no particular limitation is imposed on the ink ejection system and mode thereof, and any system and mode may be selected for use as needed. That which ejects ink by an On-Demand system using an electrothermal conversion element (heating element) or electromechanical conversion element (piezo element) in addition to a continuous system may also be used. As the mode of the ink jet recording part, in respect of the construction illustrated in FIG. 1 or 2, for example, an ink jet head of a line head mode in which ink ejection orifices are arranged in a direction of a rotation axis of the intermediate transfer member 12 may be used. A head in which ink ejection orifices are arranged within a predetermined range in a tangential or circumferential direction of the intermediate transfer member 12 may also be used to conduct recording while scanning this head in an axial direction. Heads the number of which corresponds to the number of colors of inks used in the formation of the image may be used.

As the inks used in the formation of the image, are favorably used aqueous inks. Each ink may contain a common dye, carbon black or organic pigment as a coloring material and further a resin accompanying the coloring material. In particular, a pigment ink is favorable because a recorded image good in fastness properties is obtained. No limitation is imposed on the mode of the pigment ink, and any of, for example, self-dispersion, polymer dispersion and microcapsule type pigments may be used. As a pigment dispersant used at this time, may favorably be used a dispersant resin which is water-soluble and has a weight-average molecular weight of 1,000 or more and 15,000 or less. Specific examples thereof include water-soluble vinyl resins, block copolymers or random copolymers of styrene and derivatives thereof, vinylnaphthalene and derivatives thereof, aliphatic alcohol esters of α,β-ethylenically unsaturated carboxylic acids, acrylic acid and derivatives thereof, maleic acid and derivatives thereof, itaconic acid and derivatives thereof, and fumaric acid and derivatives thereof, as well as salts thereof.

In order to improve the fastness properties of an image finally formed, a water-soluble resin and a water-soluble crosslinking agent may also be added to the ink. Any material may be used without limitation so far as it can coexist with components of the ink. As the water-soluble resin, any of the dispersant resins mentioned above may be used as it is. As the water-soluble crosslinking agent, oxazoline or carbodiimide is favorably used from the viewpoint of the stability of the ink. A reactive oligomer such as polyethylene glycol diacrylate or acryloylmorpholine may also be favorably used.

In the system using the intermediate transfer member, the ink transferred to a recording medium may be only the coloring material and high-boiling organic solvent in some cases. It is thus effective to contain a proper amount of an organic solvent in the ink for improving transferability. The organic solvent used is favorably a high-boiling and water-soluble material having a low vapor pressure. Examples of solvents favorably used include alkanediols such as 1,3-butanediol, 1,5-pentanediol, 1,2-hexanediol and 1,6-hexanediol; glycol ethers such as diethylene glycol monomethyl (or monoethyl)ether and triethylene glycol monoethyl (or monobutyl)ether; alkyl alcohols having 1 to 4 carbon atoms, such ethanol, isopropanol, n-butanol, isobutanol, sec-butanol and tert-butanol; carboxylic acid amides such as N,N-dimethylformamide and N,N-dimethylacetamide; ketones and ketone alcohols such as acetone, methyl ethyl ketone and 2-methyl-2-hydroxypentane-4-one; cyclic ethers such as tetrahydrofuran and dioxane; glycerol; alkylene glycols such as ethylene glycol, diethylene glycol, triethylene glycol, tetraethylene glycol, 1,2- or 1,3-propylene glycol, 1,2- or 1,4-butylene glycol and polyethylene glycol; polyhydric alcohols such as thiodiglycol and 1,2,6-hexanetriol; heterocyclic compounds such as 2-pyrrolidone, N-methyl-2-pyrrolidone, 1,3-dimethyl-2-imidazolidinone and N-methylmorpholine; and sulfur-containing compounds such as dimethyl sulfoxide. Two or more compounds among these may also be selected and mixed for use.

The ink used in the present invention may contain various additives such as a pH adjustor, a rust preventive, a preservative, a mildewproofing agent, an antioxidant, an anti-reducing agent, a neutralizer for the water-soluble resin and a salt in addition to the above-described components.

A surfactant is also favorably added, as needed, to suitably adjust the surface tension of the ink before use. No limitation is imposed on the surfactant so far as the storage stability of the ink is not affected, and any surfactant may be suitably selected for use. Examples of the surfactant include anionic surfactants such as fatty acid salts, salts of higher alcohol sulfates, salts of liquid fatty oil sulfates and alkylallylsulfonic acid salts; and nonionic surfactants such as polyoxyethylene alkyl esters, polyoxyethylene sorbitan alkyl esters, acetylene alcohols and acetylene glycols. Two or more compounds among these may also be suitably selected for use.

No limitation is imposed on the compounding ratio among the component making up the ink, and the ink may be suitably prepared within an ejectable range according to the ejection force and nozzle diameter of the ink jet head selected. In general, an ink prepared by using 0.1% or more and 10% or less of the coloring material, 5% or more and 40% or less of a solvent other than water, 0.01% or more and 5% or less of the surfactant and the balance of pure water may be used.

Water-and-solvent-removing units for accelerating removal of water and solvent component in ink by which image has been formed:

If the time interval between the step of forming the intermediate image on the intermediate transfer member and the step of transferring the image to a recording medium, which will be described subsequently, is extremely short, it is considered that the amount of water in the ink may not be lowered to an allowable amount of water for the recording medium, in some cases. In view of such a case, the following units may be arranged between a position where the intermediate image is formed and a position where the transfer is conducted as shown in the image forming apparatus illustrated in FIGS. 1 and 2 to accelerate the removal of water and solvent components in the ink. In short, a water and solvent removal accelerating device 16 of the type of a blower may be arranged (a hot air blower may also be arranged). In addition, a heater 17 may be arranged in the substrate (a back side of the intermediate transfer member 12).

Transfer unit for transferring intermediate image to recording medium:

The intermediate image formed on the intermediate transfer member 12 is transferred to a recording medium 18, which may be continuous paper such as roll paper or fanfold paper in addition to a cut sheet, by means of a transfer unit. The recording medium 18 is brought into contact with the image forming surface of the intermediate transfer member 12 by a pressure roller 19 to receive the ink. In the present invention, water in the ink on the intermediate transfer member 12 is evaporated at this stage, and the viscosity of the ink is increased, so that a good image can be formed even on a recording medium with small ink absorbable amount. In addition, the recording medium 18 on which the image has been formed through the intermediate transfer member in the above-described manner is brought to have excellent surface smoothness by pressing it by fixing rollers 22. The fixing rollers may be combined with heating rollers, thereby allowing the resulting printed article to have fastness properties at once.

Cleaning Unit:

The ink jet recording apparatus according to the present invention may also have a cleaning unit for the intermediate transfer member. The cleaning is intended to remove the ink and ink viscosity increasing component minutely remaining on the intermediate transfer member through a series of recording steps. As the unit for conducting the cleaning, is desirably used a direct washing unit by washing or wiping with a liquid while applying the liquid in a showered state or by bringing the intermediate transfer member into contact with the liquid surface, or a unit for conducting wiping by bringing a wetted molleton roller into contact with the surface. Quite naturally, it is also effective to use these units in combination. In addition, it is also effective, if necessary, to dry the surface of the intermediate transfer member by bringing a dried molleton roller into contact with the surface or conducting blowing.

As a liquid used in the cleaning, may be used, for example, a mixed liquid of the compound represented by the general formula (1) and water (containing a compound such as ethylene glycol as needed). A unit can be thereby used both as the unit for applying the compound represented by the general formula (1) (additional modification treatment unit) and as the cleaning unit. The above-described mixed liquid is used in the cleaning unit, whereby the residue on the surface of the intermediate transfer member can be removed, and at the same time, the effect to retain the hydrophilicity of the intermediate transfer member can be further enhanced as the additional modification treatment unit. In FIG. 2, the unit 20 for applying the compound represented by the general formula (1) is used as the additional modification treatment unit, and the application unit 20 (duplicate use) and the unit 21 for removing the compound represented by the general formula (1) are used as the cleaning unit.

When the recording apparatus is suspended for a long period of time, the apparatus is shut down in such a state that the mixed liquid has been applied, whereby the effect to retain the hydrophilicity of the surface of the intermediate transfer member can be further enhanced. Incidentally, the intermediate transfer member of the present invention, on which the modification treatment has been made, can retain the hydrophilicity on the intermediate transfer member over a long period of time by conducting the surface modification once. Therefore, the cleaning step intended to retain the hydrophilicity of the intermediate transfer member is favorably conducted according to the number of sheets subjected to the printing process according to the removal of the residue on the surface of the transfer member without need to frequently conduct the cleaning step.

Fixing Step:

As described above, the recording medium on which the image has been recorded after the transfer may be pressed by rollers (pressure rollers 22 in FIG. 1) as an additional step to enhance its surface smoothness. At this time, it is favorable to heat the rollers because the fastness properties of the image may be more improved in some cases.

The present invention will hereinafter be described more specifically by Examples of the present invention and Comparative Examples. Needless to say, the present invention is not limited to the following Examples. Incidentally, “parts” or “part” in the following description are based on mass unless expressly noted.

Preparation of Application Treatment Liquids Used in Surface Modification of Intermediate Transfer Member:

Application treatment liquids 1 to 12 to be applied to the surface of the intermediate transfer member were prepared by mixing a water-soluble organic solvent and ion-exchanged water according to their corresponding compositions shown in Table 1. Incidentally, water-soluble organic solvents used in the application treatment liquids 1 to 6 are compounds satisfying the general formula (1), but water-soluble organic solvents used in the application treatment liquids 7 to 12 are compounds not satisfying the general formula (1).

TABLE 1

| | | Compounding | Compounding |
|---|---|---|---|
| | | amount of | amount of |
| | | water-soluble | ion- |
| | Water-soluble | organic | exchanged |
| | organic solvent | solvent | water |
| Application | Polyethylene | 50 parts | 50 parts |
| treatment liquid | glycol (weight- | | |
| 1 | average molecular | | |
| | weight 600) | | |
| Application | Polyethylene | 50 parts | 50 parts |
| treatment liquid | glycol (weight- | | |
| 2 | average molecular | | |
| | weight 200) | | |
| Application | Triethylene glycol | 50 parts | 50 parts |
| treatment liquid | | | |
| 3 | | | |
| Application | Polyethylene | 40 parts | 20 parts |
| treatment liquid | glycol (weight- | | |
| 4 | average molecular | | |
| | weight 600) | | |
| | Ethylene glycol | 40 parts | |
| Application | Polyethylene | 40 parts | 50 parts |
| treatment liquid | glycol (weight- | | |
| 5 | average molecular | | |
| | weight 600) | | |
| | Glycerol | 10 parts | |
| Application | Polypropylene | 50 parts | 50 parts |
| treatment liquid | glycol (weight- | | |
| 6 | average molecular | | |
| | weight 600) | | |
| Application | Commercially | 50 parts | 50 parts |
| treatment liquid | available | | |
| 7 | detergent of alkyl | | |
| | ether sulfate salt | | |
| Application | Triethylene glycol | 50 parts | 50 parts |
| treatment liquid | monobutyl ether | | |
| 8 | | | |
| Application | 1,2-Hexanediol | 50 parts | 50 parts |
| treatment liquid | | | |
| 9 | | | |
| Application | Ethylene glycol | 50 parts | 50 parts |
| treatment liquid | | | |
| 10 | | | |
| Application | Diethylene glycol | 50 parts | 50 parts |
| treatment liquid | | | |
| 11 | | | |
| Application | 1,5-Pentanediol | 50 parts | 50 parts |
| treatment liquid | | | |
| 12 | | | |

Preparation of Solution (Reaction Liquid) Containing Ink Viscosity Increasing Component:

Reaction liquids were prepared by mixing respective components according to their corresponding compositions shown in Table 2, sufficiently stirring the resultant mixtures and then filtering the mixtures under pressure through a microfilter (product of Fuji Photo Film Co., Ltd.) having a pore size of 3.0 μm.

TABLE 2

| | Reaction | Reaction | Reaction |
|---|---|---|---|
| | liquid 1 | liquid 2 | liquid 3 |
| Calcium | 50 parts | | |
| nitrate | | | |
| tetrahydrate | | | |
| Calcium | | 30 parts | |
| chloride | | | |
| dihydrate | | | |
| Glutaric acid | | | 35 parts |
| Glycerol | 10 parts | | 10 parts |
| 1,5- | | 10 parts | |
| Pentanediol | | | |
| Acetylenol | 1 part | 1 part | 1 part |
| E100 (trade | | | |
| name, product | | | |
| of Kawaken | | | |
| Fine Chemicals | | | |
| Co., Ltd.) | | | |
| Ion-exchanged | 39 parts | 59 parts | 54 parts |
| water | | | |

Preparation of Black Pigment Dispersion Liquid:

Ten parts of a pigment (carbon black (trade name: Monarch 1100, product of Cabot Co.)), 4 parts of Resin A and 88 parts of ion-exchanged water were mixed and dispersed for 3 hours by means of a batch type vertical sand mill. Resin A is a resin obtained by neutralizing a styrene-ethyl acrylate-acrylic acid terpolymer (acid value: 150, weight-average molecular weight: 8,000) with potassium hydroxide. Thereafter, coarse particles were removed from the resultant dispersion liquid by a centrifugal treatment, and the thus treated dispersion liquid was filtered under pressure through a microfilter (product of Fuji Photo Film Co., Ltd.) having a pore size of 3.0 μm to obtain a black pigment dispersion liquid having a pigment concentration of 10% by mass.

Preparation of Cyan Pigment Dispersion Liquid:

Ten parts of a pigment (C.I. Pigment Blue 15:3), 4 parts of Resin A and 88 parts of ion-exchanged water were mixed and dispersed for 3 hours by means of a batch type vertical sand mill. Thereafter, coarse particles were removed from the resultant dispersion liquid by a centrifugal treatment, and the thus treated dispersion liquid was filtered under pressure through a microfilter (product of Fuji Photo Film Co., Ltd.) having a pore size of 3.0 μm to obtain a cyan pigment dispersion liquid having a pigment concentration of 10% by mass.

Preparation of Magenta Pigment Dispersion Liquid:

Ten parts of a pigment (C.I. Pigment Red 122), 4 parts of Resin A and 88 parts of ion-exchanged water were mixed and dispersed for 3 hours by means of a batch type vertical sand mill. Thereafter, coarse particles were removed from the resultant dispersion liquid by a centrifugal treatment, and the thus treated dispersion liquid was filtered under pressure through a microfilter (product of Fuji Photo Film Co., Ltd.) having a pore size of 3.0 μm to obtain a magenta pigment dispersion liquid having a pigment concentration of 10% by mass.

Preparation of Yellow Pigment Dispersion Liquid:

Ten parts of a pigment (C.I. Pigment Yellow 74), 4 parts of Resin A and 88 parts of ion-exchanged water were mixed and dispersed for 3 hours by means of a batch type vertical sand mill. Thereafter, coarse particles were removed from the resultant dispersion liquid by a centrifugal treatment, and the thus treated dispersion liquid was filtered under pressure through a microfilter (product of Fuji Photo Film Co., Ltd.) having a pore size of 3.0 μm to obtain a yellow pigment dispersion liquid having a pigment concentration of 10% by mass.

Preparation of Ink:

Inks used in the present invention were prepared by mixing respective components according to their corresponding compositions shown in Table 3, sufficiently stirring the resultant mixtures and then filtering the mixtures under pressure through a microfilter (product of Fuji Photo Film Co., Ltd.) having a pore size of 3.0 μm.

TABLE 3

| | Black | Cyan | Magenta | Yellow |
|---|---|---|---|---|
| | ink | ink | ink | ink |
| Black pigment | 30 parts | | | |
| dispersion liquid | | | | |
| (pigment | | | | |
| concentration: 10% by | | | | |
| mass) | | | | |
| Cyan pigment | | 30 parts | | |
| dispersion liquid | | | | |
| (pigment | | | | |
| concentration: 10% by | | | | |
| mass) | | | | |
| Magenta pigment | | | 30 parts | |
| dispersion liquid | | | | |
| (pigment | | | | |
| concentration: 10% by | | | | |
| mass) | | | | |
| Yellow pigment | | | | 30 parts |
| dispersion liquid | | | | |
| (pigment | | | | |
| concentration: 10% by | | | | |
| mass) | | | | |
| Glycerol | 10 parts | 10 parts | 10 parts | 10 parts |
| Ethylene glycol | 5 parts | 5 parts | 5 parts | 5 parts |
| Acetylenol E100 | 1 part | 1 part | 1 part | 1 part |
| (trade name, product | | | | |
| of Kawaken Fine | | | | |
| Chemicals Co., Ltd.) | | | | |
| Ion-exchanged water | 54 parts | 54 parts | 54 parts | 54 parts |

Recording Apparatus

The above-described application treatment liquid which is used in the surface modification of the intermediate transfer member and contains the water-soluble organic solvent, the solution (reaction liquid) containing the ink viscosity increasing component and the inks were used to conduct recording by means of an ink jet recording apparatus 1 illustrated in FIG. 1 or an ink jet recording apparatus 2 illustrated in FIG. 2. Incidentally, the ink jet recording apparatus 1 and 2 are equipped with the following units: an intermediate transfer member 12 arranged on a substrate 11; a roll coater corresponding to the coating device 14 in FIG. 2 as the application unit; an ink jet recording part 15 (nozzle density: 1,200 dpi, ejection quantity: 4 pl; drive frequency: 12 kHz) as the ink jet recording unit; a blower 16 and a heating roller corresponding to the heater 17 as the water-and-solvent-component-removing units; a pressure roller 19 as the transfer unit to printing paper that is the recording medium 18; and fixing rollers 22.

The ink jet recording apparatus 2 is further equipped with a molleton roller which is wetted with the application treatment liquid shown in Table 1 and corresponds to the application unit 20 in FIG. 2, as the additional modification treatment unit and cleaning unit. The ink jet recording apparatus is also equipped with a dried molleton roller as the removal unit 21 for the application treatment liquid containing the water-soluble organic solvent.

The application treatment liquids and reaction liquids used in Examples and Comparative Examples are shown in Table 4.

TABLE 4

| | Application treatment | |
|---|---|---|
| | liquid | Reaction liquid |
| Example 1 | Application treatment | Reaction liquid |
| | liquid 1 | 1 |
| Example 2 | Application treatment | Reaction liquid |
| | liquid 1 | 3 |
| Example 3 | Application treatment | Reaction liquid |
| | liquid 2 | 2 |
| Example 4 | Application treatment | Reaction liquid |
| | liquid 3 | 1 |
| Example 5 | Application treatment | Reaction liquid |
| | liquid 4 | 3 |
| Example 6 | Application treatment | Reaction liquid |
| | liquid 5 | 3 |
| Example 7 | Application treatment | Reaction liquid |
| | liquid 6 | 1 |
| Comparative | Application treatment | Reaction liquid |
| Example 1 | liquid 7 | 1 |
| Comparative | Application treatment | Reaction liquid |
| Example 2 | liquid 8 | 1 |
| Comparative | Application treatment | Reaction liquid |
| Example 3 | liquid 9 | 3 |
| Comparative | Application treatment | Reaction liquid |
| Example 4 | liquid 10 | 1 |
| Comparative | Application treatment | Reaction liquid |
| Example 5 | liquid 11 | 1 |
| Comparative | Application treatment | Reaction liquid |
| Example 6 | liquid 12 | 3 |

Incidentally, in Examples and Comparative Examples, an intermediate transfer member obtained according to the following procedure and arranged on the substrate was used in the ink jet recording apparatus 1 and 2. An intermediate transfer member formed of a silicone rubber (product of Shinetsu Kagaku Co., Ltd., trade name: KE-12, rubber hardness: 40°, thickness: 0.2 mm) was used and subjected to surface modification under the following conditions by an atmospheric plasma treatment apparatus (manufactured by KEYENCE CORPORATION, trade name: ST-7000).

Treatment distance: 5 mm
Plasma mode: High
Treatment rate: 100 mm/sec.

After the surface of the intermediate transfer member was then immersed for 1 hour in the application treatment liquid shown in Table 1, the surface was washed with water and dried, and this intermediate transfer member was wound on an aluminum drum that is the substrate.

### Recording Using Ink Jet Recording Apparatus 1:

The surface of the intermediate transfer member provided on the ink jet recording apparatus 1 was coated with the reaction liquid shown in Table 2 by a roll coater. A mirror-reversed intermediate image was then formed on the intermediate transfer medium with the 4 color inks (black, cyan, magenta and yellow) shown in Table 3 by the ink jet recording part 15 (nozzle density: 1,200 dpi, ejection quantity: 4 pl; drive frequency: 12 kHz).

The intermediate image on the intermediate transfer member was then heated by the heating roller (surface temperature: 60° C.) provided at a position coming into contact with a back side of the intermediate transfer member to accelerate the evaporation of water. Air was further blown against the surface of the recorded image on the intermediate transfer member by the blower provided between the ink jet recording part and the pressure roller.

The intermediate transfer member after the above-described series of steps was brought into contact with printing paper (product of Nippon Paper Co., Ltd., Npi Coat, A-sized, ream weight: 40.5 kg) having low ink absorbency by the pressure roller to transfer the intermediate image on the intermediate transfer member.

### Recording Using Ink Jet Recording Apparatus 2:

Recording was conducted under the same conditions as in the ink jet recording apparatus 1. In the ink jet recording apparatus 2, the molleton roller which is wetted with the application treatment liquid shown in Table 1 and corresponds to the additional modification treatment unit and cleaning unit was further brought into contact with the intermediate transfer member after the transfer to apply the application treatment liquid thereto. When recording was conducted again, the application treatment liquid on the intermediate transfer member was removed by the dried molleton roller that is the removal unit of the application treatment liquid containing the water-soluble organic solvent.

Evaluation of Intermediate Transfer Member as to Hydrophilicity:

Pure water was applied for static contact angle measurement to the surface of the intermediate transfer member to evaluate the intermediate transfer member as to the ability to retain the hydrophilicity. After the surface of the intermediate transfer member on which the surface modification treatment with plasma had been made was immersed for 1 hour in the application treatment liquid containing the water-soluble organic solvent shown in Table 1, the surface was washed with water and dried. At this time, the static contact angle of pure water with respect to the surface of the intermediate transfer member was regarded as an initial contact angle. Incidentally, the static contact angle of pure water was measured by the droplet method using an automated contact angle meter DM700 Model (manufactured by KYOWA INTERFACE SCIENCE CO., LTD.). More specifically, a needle having a needle diameter of 22 G (inner diameter: 0.4 mm, outer diameter: 0.7 mm) was used to measure an angle of pure water dropped on the surface of the intermediate transfer member at its end surface coming into contact with the surface of the intermediate transfer member.

Evaluation 1 of Hydrophilicity:

After recording was conducted by the ink jet recording apparatus 1 under the above-described conditions, and the surface of the intermediate transfer member was then left to stand for 10 days in a bared state, the contact angle of pure water was measured to determine the variation (Δθ) of the contact angle with respect to the initial contact angle, thereby making evaluation according to the following criteria.

Evaluation 2 of Hydrophilicity:

After recording was conducted by the ink jet recording apparatus 2, the intermediate transfer member was left to stand for 10 days. Incidentally, after the recording using the ink jet recording apparatus 2, the surface of the intermediate transfer member is in a state being coated with the water-soluble organic solvent by the contact of the molleton roller wetted with the application treatment liquid containing the water-soluble organic solvent shown in Table 1. Thereafter, the water-soluble organic solvent applied to the intermediate transfer member was removed by washing with water to measure the contact angle of pure water with respect to the surface of the intermediate transfer member, thereby determining the variation (Δθ) of the contact angle with respect to the initial contact angle, thereby making evaluation according to the following criteria like Evaluation 1 of hydrophilicity. The results are shown in Table 5.

Incidentally, all the contact angles of pure water with respect to the surface of the intermediate transfer member after the surface of the intermediate transfer member on which the surface modification treatment with plasma had been made was immersed for 1 hour in the application treatment liquid containing the water-soluble organic solvent shown in Table 1 exhibited a value within a range of 30±10°.

AA: The variation (Δθ) of the contact angle with respect to the initial contact angle is less than 10°;
A: The variation (Δθ) of the contact angle with respect to the initial contact angle is 10° or more and less than 20°;
B: The variation (Δθ) of the contact angle with respect to the initial contact angle is 20° or more and less than 40°;
C: The variation (Δθ) of the contact angle with respect to the initial contact angle is 40° or more.

Evaluation of the Ability to Hold Image:

The intermediate transfer member after Evaluation 1 of hydrophilicity was installed in the ink jet recording apparatus 1 to conduct recording of a character image under the above-described conditions. Evaluation of an intermediate image on the intermediate transfer member was visually made before the first recording to evaluate the intermediate transfer member as to the ability to hold the image according to the following criteria.

A: Disturbance of the intermittent image is not observed;
B: Disturbance of the intermittent image is somewhat observed;
C: Disturbance of the intermittent image is clearly observed.

TABLE 5

| | | | Evaluation of |
|---|---|---|---|
| | Evaluation 1 | Evaluation 2 | the ability to |
| | of hydrophilicity | of hydrophilicity | hold image |
| Example 1 | AA | AA | A |
| Example 2 | AA | AA | A |
| Example 3 | AA | AA | A |
| Example 4 | A | AA | A |
| Example 5 | AA | AA | A |
| Example 6 | AA | AA | A |
| Example 7 | A | AA | A |
| Comparative | B | A | A |
| Example 1 | | | |
| Comparative | C | A | B |
| Example 2 | | | |
| Comparative | C | A | B |
| Example 3 | | | |
| Comparative | C | C | C |
| Example 4 | | | |
| Comparative | C | A | B |
| Example 5 | | | |
| Comparative | C | C | C |
| Example 6 | | | |

As apparent from the results described above, the following matters become feasible when the transfer ink jet recording apparatus according to the present invention is used. In short, the hydrophilicity of the intermediate transfer member can be stably retained, while it is gradually changed when the conventional intermediate transfer member is left to stand for a long period of time, and a good image can be formed owing to the high ability to hold the intermediate image on the intermediate transfer member.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-158795, filed Jul. 13, 2010, which is hereby incorporated by reference herein in its entirety.

What is claimed is:

1. A transfer ink jet recording apparatus comprising
a substrate;
an intermediate transfer member that is arranged on the substrate and has a surface containing at least one material of a fluorine-containing rubber and a silicone rubber, said surface being subjected to a modification treatment by a plasma treatment and an application treatment with a compound represented by the following general formula (1):
HO-(AO)ₙ—H General formula (1)
wherein A is an ethylene or propylene group, and n is an integer of 3 to 50;
an application unit for applying a component that causes ink viscosity increase to the modification-treatment-subjected surface of the intermediate transfer member;
an ink jet recording unit for ejecting an ink on the intermediate transfer member to which the component has been applied to form an intermediate image; and
a transfer unit for transferring the intermediate image formed on the intermediate transfer member to a recording medium.

2. The transfer ink jet recording apparatus according to claim 1, further comprising a unit for applying the compound represented by the general formula (1) on the surface of the intermediate transfer member.

3. The transfer ink jet recording apparatus according to claim 1, wherein A in the general formula (1) is an ethylene group.

4. The transfer ink jet recording apparatus according to claim 1, wherein the ink is a pigment ink, and the component that causes ink viscosity increase is at least one of a hydrogen ion and a metal ion.
